(19) United States
(12) Patent Application Publication
(10) Pub. No.: US 2025/0042640 A1
(43) Pub. Date: Feb. 6, 2025

(54) ATTACHABLE ADHESIVE MOISTURE ADJUSTING SACHET

(71) Applicant: Zachary E ZIVKOVICH, Austin, TX (US)

(72) Inventor: Zachary E ZIVKOVICH, Austin, TX (US)

(21) Appl. No.: 18/796,093

(22) Filed: Aug. 6, 2024

Related U.S. Application Data
(60) Provisional application No. 63/531,006, filed on Aug. 6, 2023.

(51) Int. Cl. B65D 81/26; A61J 1/03

(52) U.S. Cl. CPC B65D 81/268; A61J 1/03

(57) ABSTRACT

A device for minimizing consumer frustration with the usage of moisture adjusting sachets in pill bottles, while minimizing cost for manufacturers, and enabling usage across all pill bottle designs. The design is that of an attachable adhesive moisture adjusting sachet, such that upon removal of the pill bottle safety seal, the sachet can be extracted from inside the pill bottle, and attached by the consumer, to the bottom of the pill bottle cap. This removes the frustration that can be caused by the sachet clogging the pill bottle mouth when consumers are attempting to extract pills. Further, it encourages consumers to avoid discarding the sachets, which can reduce the lifespan and/or effectiveness of the pills contained within the pill bottle.

### CROSS-REFERENCE TO RELATED APPLICATIONS

This application claims priority to U.S. provisional application Ser. No. 63/531,006, filed on Aug. 6, 2023, and titled “ATTACHABLE ADHESIVE MOISTURE ADJUSTING SACHET”, which is incorporated herein in its entirety by reference.

### FIELD OF INVENTION

This invention generally relates to consumer goods packaging, and particularly to desiccant packets, hydrogel packets, and oxygen absorption packets.

### BACKGROUND OF THE INVENTION

Moisture adjusting packets (aka sachets)—usually filled with silica gel to remove moisture, or hydrogel to supply moisture, are often required to keep medications within a specified humidity range, due to chemical or physical properties of said medications.

Moisture adjusting packets (i.e., desiccant sachets) are commonly used with pill bottles and other perishable products, typically as a loose packet in the container. Integrating moisture adjusting packets into the structure or packaging of pill bottles and pill bottle caps has been proposed by U.S. Pat. No. 6,986,807B2, CA2555742C, EP1638856A1, WO2013114375A1, and US20060000837A1. The purpose of these integrated sachets is to prevent sachets from being lost or from obstructing the flow of pills out of the bottle when pills are being extracted. Some consumers discard the needed moisture adjusting sachets upon first extraction from pill bottles, potentially resulting in degraded performance of the product over the lifetime of the pill bottle, particularly those that contain weeks' or months'-worth of supply. Other examples (U.S. Pat. Nos. 5,686,161, 5,667,863A) would require a change in the production process when pill bottles are filled and sealed.

Many previous designs missed the mark in that the companies that use pill bottles to package their product want to minimize the cost of pill bottles, while still meeting the basic engineering requirements to deliver a safe and effective product to their end consumers. From the point of view of these companies, the additional cost that investing in specialized pill bottles or product process changes is not justified by avoiding moisture adjusting sachets blocking the flow of pills during pill extraction.

What is needed is a design solution that works with existing pill bottle structures and configurations, which will solve this problem for consumers, while incurring only negligible cost for the companies making the purchase decision.

A common feature of previous moisture adjusting devices has been attempted integration of the moisture adjusting packet into the design of the pill bottle itself, or use of a design that is not compatible with how the majority of pill bottles function.

A common problem associated with previous moisture adjusting devices being directly integrated with the pill bottles themselves is that the companies that use pill bottles to package their product, primarily want to minimize the cost of said pill bottles, while still meeting the basic engineering requirements to deliver a safe and effective product to their end consumers. From the point of view of these organizations, the frustration that their end consumers suffer in this regard is not worth the additional cost that investing in specialized packaging, or adjusting their production processes would incur.

Accordingly, improvements are sought in the design of these moisture adjusting sachets, so they can serve their primary function, without causing consumer frustration upon pill extraction, and without significantly increasing costs.

### SUMMARY OF THE INVENTION

While the way that the present invention addresses the disadvantages of the prior art will be discussed in greater detail below, in general, the present invention provides a design for a moisture adjusting sachet that will not impede the flow of pills out of a bottle, using a design that is compatible with most existing pill bottle structures and configurations.

A primary aspect of the invention is that it forms a system between the user, the pill bottle, and the device itself, which has two stages of use. In its first stage the invention works in a fashion similar to conventional moisture adjusting sachets.

First, the pills are placed in a pill bottle. Second, the attachable adhesive moisture adjusting sachet is inserted loose into the pill bottle (as shown in the diagram for U.S. Pat. No. 8,029,842B2). Third, a foil/plastic/paper safety seal is typically affixed to the top of a pill bottle. Fourth, the pill bottle cap is attached. Finally, an outer plastic/paper tamper resistant seal may be applied over the cap. The attachable adhesive moisture adjusting sachet adsorbs moisture in this position as long as the pill bottle remains sealed.

In the second stage, the consumer initially opens the pill bottle and removes any outer and inner seals from the pill bottle, and removes the attachable adhesive moisture adjusting sachet as well. Once the attachable adhesive moisture adjusting sachet is removed from the pill bottle, users will remove a brightly-colored, non-stick tab, exposing a bio-safe adhesive patch at one end of the sachet. The users will then stick the adhesive patch of the sachet to the underside of the cap of the pill bottle. They will remove any needed pills, and then replace the cap of the pill bottle, with the attachable adhesive moisture adjusting sachet now taking up the space between the underside of the cap, and the remaining pills in the pill bottle. The attachable adhesive moisture adjusting sachet would then continue to regulate the moisture levels in the pill bottle but will remain attached to the top of the pill bottle for the remainder of its useful lifetime, without impeding the flow of pills out of the pill bottle.

The shape of the attachable adhesive moisture adjusting sachet, and the bio-safe adhesive patch used will be strong enough to withstand normal usage of a pill bottle, for example if pills are jostled around within a pill bottle as they might be during travel. The sachet may need to be reattached if a pill bottle, with pills remaining in it, is vigorously shaken, or if the structure of the pill bottle itself is compromised. Further, the shape of the device will be narrow enough to easily be slid into and out of the mouth of a pill bottle but will be voluminous enough to contain the necessary amount of moisture adjusting material.

One aspect of the invention, features in some embodiments, a form of moisture permeable packaging that contains a moisture adjusting material (such as silica gel for moisture removal, or hydrogel for supplying moisture), and on one or more sides, at least one non-stick tab that can be removed to expose an adhesive patch that will be used by the consumer to attach the sachet to the underside of the cap of the pill bottle, thus, the moisture adjusting sachet will still adsorb moisture, without impeding the flow of pills out of the pill bottle for the remainder of the time the pill bottle is in use.

Another aspect of the invention features a shape selected for ease of insertion and removal from a pill bottle. The shape described here is extremely efficient in terms of cost minimization. Silica gel, hydrogel or another moisture adjusting substance is placed within a sheet of moisture permeable paper, then folded and sealed in such a way as to envelope the moisture adjusting substance inside the packaging, and to create a strong, triangular structure that results in the device having a planar surface that is perpendicular to the length of the main section of the sachet, by which it can be attached to the underside of the pill bottle cap. The main body of the device is where the moisture adjusting material would be located. This version of the design would provide a highly cost-effective method for enclosing the moisture adjusting material in an outer shell that would not impede moisture absorption, and a shape that can be easily placed into and removed from a pill bottle.

In some embodiments, other than the shape described above, the moisture adjusting material may be sealed in other geometries or moisture permeable packaging materials that still would allow for the sachet to be attached to the underside of a pill bottle cap by the consumer, upon safety seals being removed from the pill bottle. Alternative embodiments may unnecessarily incur additional cost because of additional complexity.

This embodiment affords greater flexibility and better functional integration because, regardless of the design of the pill bottle itself, the attachable adhesive moisture adjusting sachet can be placed into the pill bottle by manufacturers in the same way as a normal moisture adjusting sachet (such as a packet of silica gel) can be, and extracted from the pill bottle by consumers in the same way as a normal moisture adjusting sachet can be extracted.

In contrast, some other previous designs required changing the structure of the pill bottle (U.S. Pat. No. 6,986,807B2, CA2555742C, EP1638856A1, WO2013114375A1, US20060000837A1), which would require expensive changes to existing production processes for the companies that use pill bottles to package their product.

Another advantage of the present invention is the various possibilities for the placement of advertisements on the moisture adjusting sachet itself. Since consumers will interact with the sachet upon removing it from the pill bottle, removing the non-stick tab to expose the bio-safe adhesive, and sticking it to the underside of the pill bottle cap, the consumers eyes will be on the sachet for a period of time. A logo could be placed on the non-stick tab covering the adhesive, and a logo or even a short slogan could be printed on the side of the sachet. Since the consumer will now have a positive sentiment associated with the sachet as it has solved a problem, this now becomes a valuable vehicle for advertising and associating that positive feeling with a brand.

In various embodiments, the outer shell of the device could be made of some other moisture permeable material.

In other embodiments, the device comprises other mechanisms to allow the consumer to attach the moisture adjusting device to the underside of the pill bottle cap, such as a magnet, suction cup, or Velcro brand touch fastener, in lieu of the bio-safe adhesive patch.

In still other embodiments, the device could be filled with a substance to adjust the properties of the air inside the pill bottle other than moisture level, such as a dried iron-powder to reduce the oxygen level.

One aspect of the invention features, in some embodiments, a moisture adjusting packet, here referred to as the “attachable adhesive moisture adjusting sachet” device, that allows for the unimpeded flow of pills out of a standard pill bottle during pill removal, while still providing the necessary moisture adjusting capability of a standard sachet of nearly identical dimensions, during all phases of pill bottle use, via a method of the pill bottle user interacting with said device, forming a new system between said device, said user, said pill bottle, and the pill bottle cap.

In some embodiments, the attachable adhesive moisture adjusting sachet has one or more sides with at least one non-stick tab that, when removed, will expose a bio-safe adhesive to be utilized by the pill bottle user, to attach the sachet to the underside of the pill bottle cap, according to instructions printed on said sachet; all after the initial removal of said pill bottle cap, any safety seals from the pill bottle, and the initial removal of said sachet from said pill bottle.

In some embodiments, the attachable adhesive moisture adjusting sachet includes silica gel, hydrogel or another moisture adjusting substance placed within a sheet of moisture permeable paper, then folded and sealed in such a way as to first, envelope the moisture adjusting substance inside said moisture permeable paper, and second, to create a strong, structure that results in the sachet having a planar surface that is perpendicular to the length of the main body of said sachet, by which it can be attached to the underside of the pill bottle cap.

In some embodiments, the attachable adhesive moisture adjusting sachet is compatible with existing pill bottle configurations, consisting of a pill bottle and pill bottle cap, which are intended to contain pills.

In some embodiments, use of the attachable adhesive moisture adjusting sachet does not require any changes to the structure of the pill bottle and pill bottle cap.

In some embodiments, use of the attachable adhesive moisture adjusting sachet does not require any significant changes to existing automated or manual production processes (during which pills are placed into pill bottles), which currently utilize existing moisture adjusting sachets; said device can be supplemented for said existing moisture adjusting sachets with little to no change in said production process.

In some embodiments, an outer shell of the attachable adhesive moisture adjusting sachet is made primarily of a moisture permeable material which completely envelopes and contains; either a moisture removing agent such as silica gel, or a moisture supplying agent, such as hydrogel.

In some embodiments, use of the attachable adhesive moisture adjusting sachet forms a new system between the user, said device, and any standard pill bottle, which operates via a method that occurs in two stages. In the first stage of operation, works in the following way: a. pills are placed in an open pill bottle, b. the attachable adhesive moisture adjusting sachet is placed on top of the pills in the pill bottle, c. the attachable adhesive moisture adjusting sachet begins adjusting the moisture level inside said pill bottle, d. a foil/plastic/paper safety seal may be affixed to the top of said pill bottle, e. the pill bottle cap is attached, f. an outer plastic/paper seal may be applied over said pill bottle cap.

In the second stage of operation: a. the pill bottle user opens the bottle by removing any external seals, the pill bottle cap, and any safety seals applied under the pill bottle cap but on top of the pill bottle, b. the pill bottle user extracts the attachable adhesive moisture adjusting sachet from said pill bottle, c. said pill bottle user removes the brightly colored, non-stick tab, exposing a bio-safe adhesive at one end of said sachet, d. said pill bottle user utilizes the bio-safe adhesive to affix the attachable adhesive moisture adjusting sachet to the center of the underside of said pill bottle cap, e. said pill bottle user extracts any necessary pills, f. said pill bottle user reattaches said pill bottle cap to said pill bottle, g. said attachable adhesive moisture adjusting sachet now occupies the open space between the underside of the pill bottle cap, and the pills remaining in the pill bottle, h. said device continues to adjust the moisture level within said capped pill bottle, i. as more pills are needed, the pill bottle cap is removed, and the above steps e to h are repeated.

In some embodiments, a magnet, suction cup, a piece of Velcro brand touch fastener, or other mechanism affixed to the attachable adhesive moisture adjusting sachet device of claim 1, could be used in place of the non-stick tab and bio-safe adhesive, by the pill bottle user to affix said device to the underside of the pill bottle cap, in the initial operation of the device.

In some embodiments, the attachable adhesive moisture adjusting sachet is of a size that contains enough moisture adjusting material to meet chemical and engineering specifications, while also being of a shape and size that can easily be placed in, and removed from, a standard pill bottle.

In some embodiments, use of the attachable adhesive moisture adjusting sachet does not suffer from the prior art problems caused by the requirement that the moisture adjusting device be attached to the underside of the cap during the initial filling of the pill bottle with pills, as a safety seal placed between the pill bottle cap and pills residing below said safety seal, would render said prior art ineffective at adjusting the moisture level in the pill bottle, prior to the removal of said safety seal.

In some embodiments, the combination of the bio-safe adhesive and surface area of the planar surface on which said bio-safe adhesive is applied will create a bond strong enough to withstand normal usage of a pill bottle, for example if pills are jostled around within a pill bottle as they might be during travel.

In the case that the pill bottle user ignores the instructions printed on the attachable adhesive moisture adjusting sachet, it would continue to function in the same way as any moisture adjusting sachet of similar size and shape would. When used as directed, the attachable adhesive moisture adjusting sachet, removes the frustration of such sachets obstructing the flow of pills out of the bottle, reducing the likelihood that consumers will discard said moisture adjusting sachets, which could inadvertently reduce the lifespan and/or effectiveness of the pills contained within a pill bottle.

Most desiccant packages, whether a sachet or cylinder, suffer from a design that, to those with impaired vision, can look like a pill or something to consume, whereas the angular structure of the attachable adhesive moisture adjusting sachet does not at all resemble something to consume, and this fact will help prevent accidental ingestion.

### BRIEF DESCRIPTION OF THE DRAWINGS

A more complete understanding of the present invention may be derived by referring to the detailed description and claims when considered in connection with the Figures, wherein like reference numerals refer to similar elements throughout the Figures. FIGS. 1-9 describe the structure of the Attachable Adhesive Moisture Adjusting Sachet device itself from various vantage points, while FIGS. 10-16 illustrate the process by which the device is used.

FIG. 1 illustrates a front external view of one embodiment of an Attachable Adhesive Moisture Adjusting Sachet.

FIG. 2 illustrates a front-view of the Sachet device of FIG. 1 with an internal view of moisture adjusting material.

FIG. 3 illustrates a rear, external view of fully assembled Sachet device of FIGS. 1-2.

FIG. 4 illustrates a side view of fully assembled Sachet device FIGS. 1-3, with internal view of moisture adjusting material and bio-safe adhesive patch.

FIG. 5 illustrates a partially exploded side-view of the Sachet device, with three sections of Triangular Structure half-way folded, after all edge seams are sealed, prior to permanent attachment of Section Four of Triangular Structure.

FIG. 6 illustrates a partially exploded side-view of the Sachet device with three Sections of Triangular Structure almost completely folded.

FIG. 7 illustrates a partially exploded front-view of the Sachet device with all Sections of the Triangular Structure completely unfolded (except for fold 501), showing the internal facing sides of Sections One through Four (502, 504, 506, 508).

FIG. 8 illustrates a partially exploded front-view of the Sachet device with Section One (502) obscured (because Fold Two (503) is folded up at zero degrees for the purposes of this depiction) but showing the external facing sides of the remaining three Sections (504, 506, 508), of the Triangular Structure (402).

FIG. 9 illustrates a fully exploded front-view of Sachet device completely unfolded, with moisture adjusting material visible, and folds marked, but with no folds folded or seams sealed.

FIG. 10 illustrates a front-view of a pill bottle and bottle cap.

FIG. 11 illustrates a pill bottle cap removed with safety seal intact,

FIG. 12 illustrates a pill bottle, with safety seal half-way removed.

FIG. 13 illustrates a Sachet device being extracted from pill bottle.

FIG. 14 illustrates a Sachet device with red non-stick tab (208) being removed, exposing bio-safe adhesive patch/strip (202).

FIG. 15 illustrates a Sachet device being attached to the underside of bottle cap.

FIG. 16 illustrates a bottle cap (1001), with Sachet device attached, being placed back onto pill bottle (1002).

### DETAILED DESCRIPTION

The following description is of exemplary embodiments of the invention only, and is not intended to limit the scope, applicability or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, materials, components, sizes, attachment mechanisms, and the like and still fall within the scope of the present invention. Thus, the detailed description herein is presented for purposes of illustration only and not of limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

In the following description, certain terminology is used to describe certain features of one or more embodiments of the invention. For example, the term “Sachet device” or just “device” as described herein may include, but is not necessarily limited to, a sachet with an adhesive patch/strip. The Attachable Adhesive Moisture Adjusting Sachet device may be constructed from a wide variety of materials including, but not necessarily limited to, a moisture permeable paper material, moisture adjusting materials, bio-safe adhesives, and plastics.

In accordance with various aspects of the present invention includes an Attachable Adhesive Moisture Adjusting Sachet (100). Sachet 100 is shown with an outer shell is made primarily of folded moisture permeable paper material. The present invention may be used to absorb moisture from any confined space. That being said, the present invention is described herein in the exemplary context of a how a consumer would use it to keep pills in a pill bottle within the specified humidity range such that the pills themselves retain their expected effectiveness and longevity. Similarly, “sachet” as used herein, generally may be construed to mean any container which holds a moisture adjusting material such that said material can adsorb/supply moisture from/to the surrounding atmosphere in a confined space.

The term “main body”, as used herein, includes any shape for containing moisture adjusting material. Suitable main bodies may be of any shape, material, or size and in general, include rectangles and squares of different proportions, blocks, cylinders, or other more complex three-dimensional shapes.

It is understood that any process now known or later developed for forming three-dimensional shapes for containing a moisture adjusting material, with at least one side having an adhesive face that can be used by the consumer to attach the device to the underside of a pill cap may be used in accordance with the present invention.

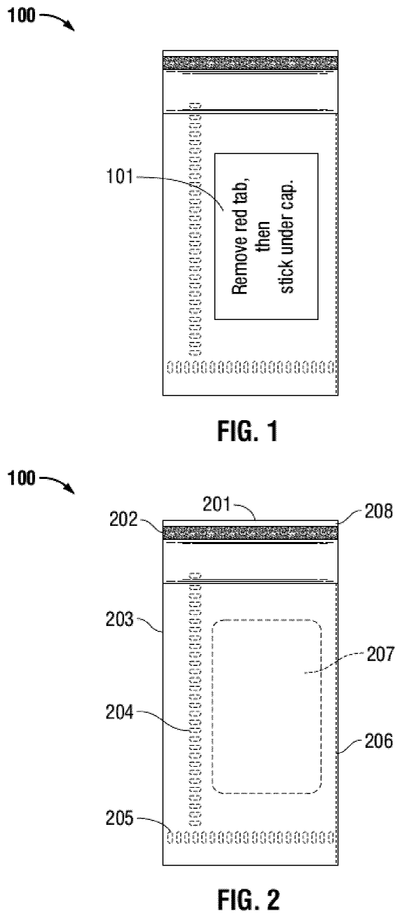

FIGS. 1-9 illustrate different views of an Attachable Adhesive Moisture Adjusting Sachet device. With reference now to FIG. 1, according to one embodiment of the present invention, a view of the fully assembled device is shown (100) from the front, including an instructional label on how to use the device (101)

With reference now to FIG. 2, a second front-view is shown according to the embodiment of the present invention in which an internal view of the moisture adjusting material (207) (such as a silica gel for moisture removal or a hydrogel for supplying moisture) is displayed, contained in the Main Body of the device (203), which is a rectangle made up of four sides. For orientation purposes, the first of the four sides—the top of the rectangle (201) is formed by the bio-safe adhesive strip (202) users will employ to attach the device to the underside of a pill bottle, after the red non-stick tab (208) is removed from the adhesive strip. The left-side of the rectangle is formed by the left-side seam (204), the bottom of the rectangle is formed by the bottom edge seam (205), and the right-side of the rectangle is formed by the right-side edge fold (206) of the main body (203).

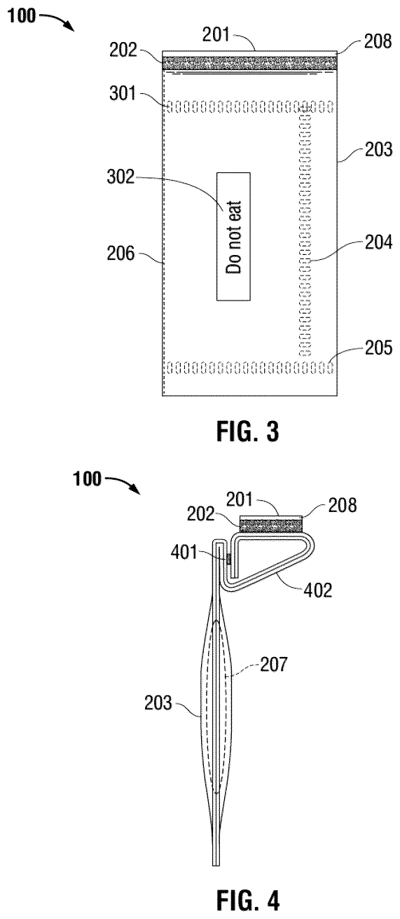

With reference now to FIG. 3, a rear-view of the fully assembled device is shown according to the embodiment of the present invention, which displays the Main Body's (203) top edge seam (301), which is obscured by the adhesive strip (202), and red non-stick tab (208) in FIG. 2. Additionally, a “Do Not Eat” safety label (302) is also displayed.

With reference now to FIG. 4, a side-view of the fully assembled device is shown according to the embodiment of the present invention, which displays an internal view of the moisture adjusting material (207), the permanent bio-safe adhesive (401), and the three-sided Triangular structure (402), formed by four Sections (502, 504, 506, 508) of the porous paper. The orientation is shown by (201) which indicates the top of the device. Also shown is the red non-stick tab (208) covering the bio-safe adhesive strip (202).

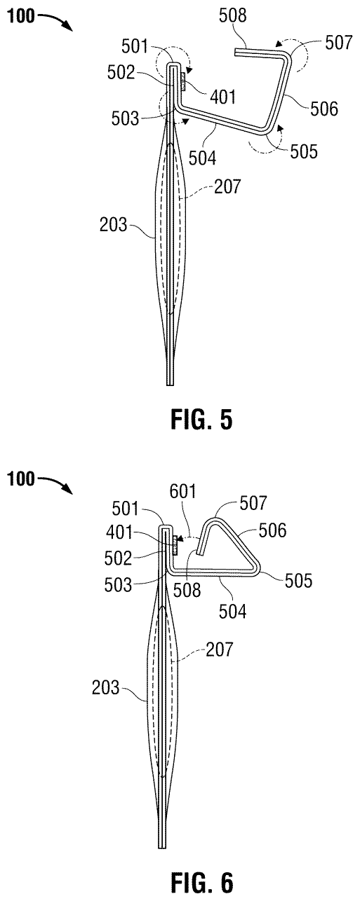

With reference now to FIG. 5, a partially exploded side-view of the device is shown according to the embodiment of the present invention, which displays one section of the Triangular Structure (402) fully folded (501), and three sections of the Triangular Structure (402) half-way folded (503, 505, 507), after all edge seams are sealed, but prior to permanent attachment of Section Four of Triangular Structure (402). Working counterclockwise, a fully folded Fold One (501) is shown which delineates the beginning of Section One (502) and the folding action and direction is indicated by a dotted semi-circular arrow, followed by half-way-folded Fold Two (503), delineating the end of Section One (502), and beginning of Section Two (504). Half-way-folded Fold Three (505) follows, delineating the end of Section Two (504), and beginning of Section Three (506). Finally half-way-folded Fold Four (507) delineates the end of Section Three (506) and the beginning of Section Four (508). Taken together, these show the ordering of the folds, and how the four sides are folded.
501—Fold One of Triangular Structure, delineating the beginning of Section One.
502—Section One (5 mm wide, as pictured) of Triangular Structure (402).
503—Fold Two of Triangular Structure, delineating the end of Section One (502), and the beginning of Section Two (504).
504—Section Two (8 mm wide, as pictured) of Triangular Structure (402).
505—Fold Three of Triangular Structure, delineating the end of Section Two (504), and the beginning of Section Three (506).
506—Section Three (8 mm wide, as pictured) of Triangular Structure (402).
507—Fold Four of Triangular Structure, delineating the end of Section Three (506), and the beginning of Section Four (508).
508—Section Four (5 mm wide, as pictured) of Triangular Structure (402).

With reference now to FIG. 6, a partially exploded side-view of the device is shown according to the embodiment of the present invention, which displays one section of the Triangular Structure (402) fully folded (501), and three sections (504, 506, 508) of the Triangular Structure (402) almost fully folded (503, 505, 507), and focuses on the process of attaching the external facing side of Section Four (508) to the internal facing side of Section One (502), via permanent bio-safe adhesive (401). This attachment motion is indicated by a dotted curved arrow (601) and occurs during the production of the device.

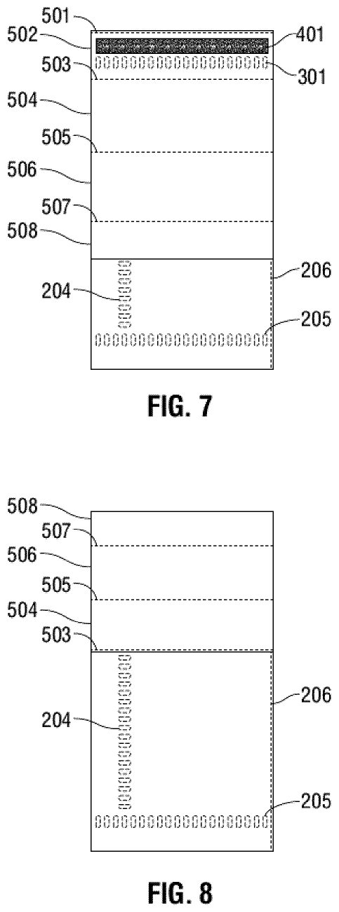

With reference now to FIG. 7, a partially exploded front-view of the device is shown according to the embodiment of the present invention, which displays all Sections of the Triangular Structure completely unfolded, except for fold 501 which has been completed here and sealed with the top edge seam (301). FIG. 7 focuses on displaying the internal facing sides of Sections One through Four (502, 504, 506, 508).

With reference now to FIG. 8, a partially exploded front-view of device is shown according to the embodiment of the present invention, which displays the external facing sides of three Sections (504, 506, 508), of the Triangular Structure (402). Section 502 is fully obscured in this view because Fold Two (503) is folded up at zero degrees as pictured. Note that in the fully assembled device, Fold Two (503) is folded at 45 degrees in the fully assembled device as pictured in FIG. 4.

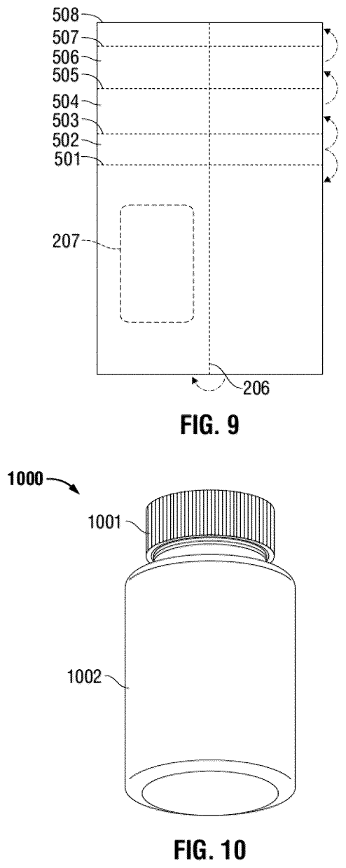

With reference now to FIG. 9, a fully exploded view of the device is shown consisting primarily of the 36 mm×36 mm sheet of porous paper (as pictured), as well as the moisture adjusting material (207) which would be contained by the Main Body of the device (203).

With reference to FIG. 9 and the proceeding figures, the production process of the device will now be described, starting with the fully unfolded piece of porous paper measuring 36 mm×36 mm (as pictured):

Step One: the moisture adjusting material would be placed in the lower left-hand quadrant as shown (207). Step Two: The Right-Side Edge Fold (206) of the Main Body (203) of the device would be folded. Step Three: The Bottom-Edge Seam (205) would be sealed. Step Four: The Left-Side Seam (204) of the Main Body (203) would be completed, overlapping the Bottom-Edge Seam (205), (as seen in FIG. 8), and running to just below Fold One (501) (as seen in FIG. 7). Step Five: The Top-Edge Seam (301) of the Main Body (203), is sealed, overlapping 204, and running just under Fold One (501) as seen in FIG. 7. Step Six: Fold One (501) is completed, folding top-to-bottom. Step Seven: Fold Two (503) is completed, folding bottom-to-top. Step Eight: Fold Three (505) is completed, folding bottom-to-top. Step Nine: Fold Four (507) is completed, folding bottom-to-top. Step Ten: The external facing side of Section Four (508) is glued to the internal facing side of Section One (502), via permanent bio-safe adhesive (401). This attachment motion is indicated by a dotted curved arrow (601) on FIG. 6, and it occurs during the production of the device. Step Eleven: The bottom of the Bio-safe adhesive strip (with the Removable Red Tab (208) already attached) is permanently attached to the top of the Triangular Structure (402), which is the external face of Side Three (506).

This completes the fully assembled device as shown in FIG. 1 (100).

With reference now to FIG. 10, a pill bottle with cap (1000) of the general type which will be used with the device is shown. For clarity in how the device will function, the pill bottle cap (1001) and pill bottle (1002) are assigned different part numbers.

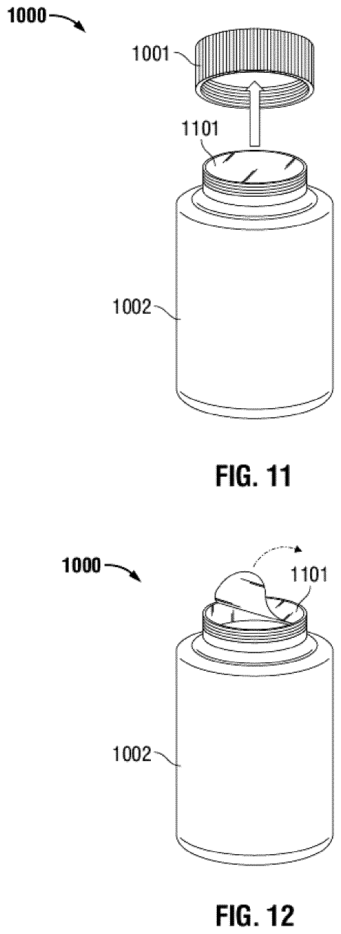

With reference now to FIG. 11, a pill bottle (1002) is shown with the cap (1001) removed but with the safety seal (1101) intact, which would prevent any moisture adjusting material permanently attached to the underside of the cap (1001), (as seen in U.S. Pat. Nos. 5,686,161A, 5,667,863A), from having any effect on the pills in the pill bottle.

During the operation of the device, with reference to FIG. 10 through FIG. 16, the way in which the device will be used in coordination with a pill bottle (1000) will now be described:

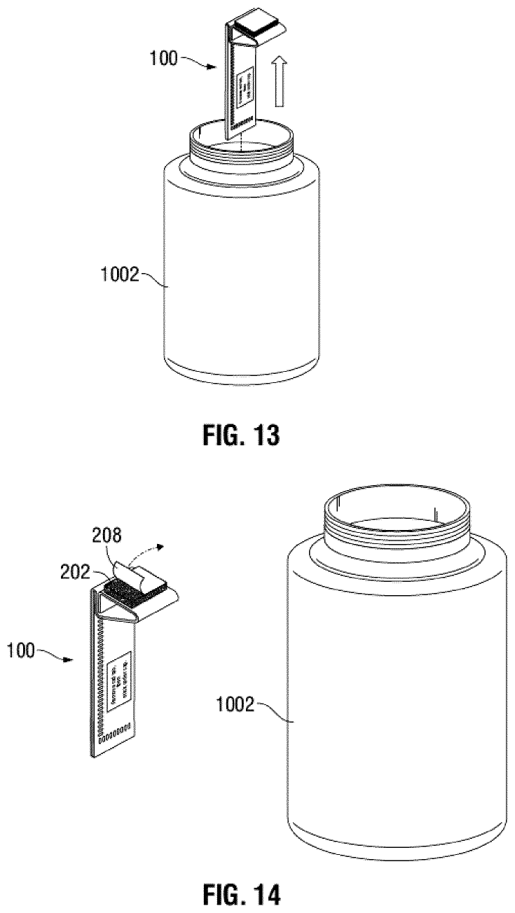

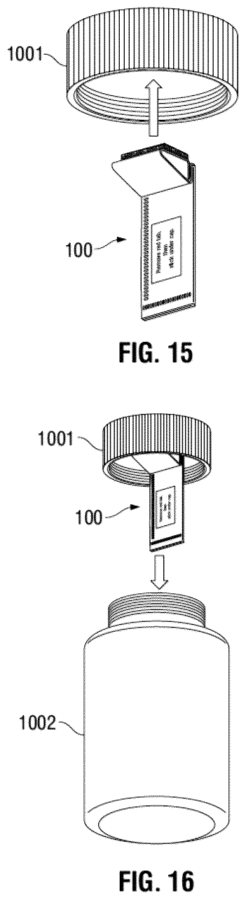

Step A: A user would start with a new, unopened bottle of pills (1000) as shown in FIG. 10. Step B: The user would remove the pill bottle cap (1001) for the first time and expose the intact safety seal (1101) as shown in FIG. 11. Step C: The user would remove the safety seal (1101) as shown in FIG. 12. Step D: The user would extract the device (100) from the pill bottle (1002) as shown in FIG. 13. Step E: The user would remove the red tab (208) from the device (100), exposing the bio-safe adhesive strip (202), as shown in FIG. 14. Step F: The user would use the bio-safe adhesive strip (202) to attach the device (100) to the underside of the pill bottle cap (1001) as shown in FIG. 15. Step G: The user would replace the pill bottle cap (1001) with the device (100) attached, on to the pill bottle (1002) and screw the cap (1001) on tightly allowing the device (100) to continue to adjust the moisture levels in said pill bottle 1000. Step H: The next time a pill is needed from the pill bottle, the user would detach the pill bottle cap (1001) with the device (100) attached, remove the required number of pills, and then loop back to Step G. The use of the attachable adhesive moisture adjusting sachet device preferably does not require any changes to the conventional structure of the pill bottle and pill bottle cap. The attachable adhesive moisture adjusting sachet device preferably does not require any changes to existing automated or manual production processes (during which pills are placed into pill bottles), which currently utilize existing moisture adjusting sachets; said device can be supplemented for said existing moisture adjusting sachets with little to no change in said production process.

The attachable adhesive moisture adjusting sachet is preferably compatible with all existing pill bottle configurations, consisting of a pill bottle and pill bottle cap, which are intended to contain pills. The attachable adhesive moisture adjusting sachet preferably requires little to no changes to existing automated or manual production processes during which pills are placed into pill bottles, which currently utilize existing moisture adjusting sachets; said device can be supplemented for said existing moisture adjusting sachets with little to no change in said production process. In the case that the pill bottle user ignores the instructions printed on the attachable adhesive moisture adjusting sachet, it would continue to function in the same way as any moisture adjusting sachet of similar size and shape would.

Finally, while the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A moisture adjusting sachet comprising:
a sachet body configured to retain a desiccant;
an adhesive patch presented on the sachet body and configured with a removable cover disposed on the adhesive patch; and
wherein the moisture adjusting sachet is configured for loose packaging with pills in a pill bottle and for subsequent attachment to the underside of a pill bottle cap by a user.

2. The attachable adhesive moisture adjusting sachet of claim 1, wherein the adhesive patch comprises a bio-safe adhesive to be utilized by a pill bottle user to attach the sachet to the underside of the pill bottle cap, according to instructions printed on said sachet; all after the initial removal of said pill bottle cap, any safety seals from the pill bottle, and the initial removal of said sachet from said pill bottle.

3. The attachable adhesive moisture adjusting sachet of claim 1, comprising at least one of silica gel, hydrogel, and moisture adjusting material disposed within a sheet of moisture permeable paper folded to envelope the at least one of silica gel, hydrogel, and moisture adjusting material inside and to provide a planar surface to present the adhesive patch to be attached to the underside of a pill bottle cap.

4. The attachable adhesive moisture adjusting sachet of claim 1, configured for use with conventional pill bottle configurations having a pill bottle and pill bottle cap.

5. The attachable adhesive moisture adjusting sachet of claim 1, comprising a moisture permeable material that envelopes and contains one of a moisture removing agent or a moisture supplying agent.

6. A moisture adjusting sachet comprising:
a sachet body configured to retain a desiccant;
at least one of a magnet, suction cup, and Velcro brand touch fastener, configured to affix the moisture adjusting sachet body to the underside of a pill bottle cap; and
wherein the sachet is configured for loose packaging with pills in a pill bottle and for subsequent attachment to the underside of a pill bottle cap by a user.

7. The attachable adhesive moisture adjusting sachet of claim 6, comprising at least one of silica gel, hydrogel, and moisture adjusting material disposed within a sheet of moisture permeable paper folded to envelope the at least one of silica gel, hydrogel, and moisture adjusting material inside and to provide a planar surface to present the adhesive patch to be attached to the underside of a pill bottle cap.

8. A method of using an attachable adhesive moisture adjusting sachet comprising the steps of:
a. placing pills in an open pill bottle;
b. placing an attachable adhesive moisture adjusting sachet with the pills in the pill bottle,
c. adjusting the moisture level inside said pill bottle with the attachable adhesive moisture adjusting sachet;
c. affixing a foil/plastic/paper safety seal to the top of said pill bottle,
d. attaching a pill bottle cap; and
e. providing user instructions for affixing the attachable adhesive moisture adjusting sachet to the underside of the pill bottle cap, prior to replacing the pill bottle cap on to the pill bottle.

9. The method of claim 8, further comprising:
a. opening the pill bottle by removing any external seals, the pill bottle cap, and any safety seals applied under the pill bottle cap but on top of the pill bottle;
b. extracting from the pill bottle the attachable adhesive moisture adjusting sachet from the pill bottle;
c. removing a non-stick tab, exposing a bio-safe adhesive patch/strip presented on the sachet,
d. affixing the attachable adhesive moisture adjusting sachet to the center of the underside of said pill bottle cap using the bio-safe adhesive patch/strip;
e. reattaching the pill bottle cap to the pill bottle with the attachable adhesive moisture adjusting sachet occupying an open space between the underside of the pill bottle cap, and pills remaining in the pill bottle.
